(19) United States
(12) Patent Application Publication
(10) Pub. No.: US 2011/0289686 A1
(43) Pub. Date: Dec. 1, 2011

(54) Partitioned Bed Sheets

(76) Inventor: David Christopher Chose, Cypress, TX (US)

(21) Appl. No.: 13/113,040

(22) Filed: May 21, 2011

Related U.S. Application Data
(60) Provisional application No. 61/349,769, filed on May 28, 2010.

(51) Int. Cl. A47G 9/04; B23P 11/00; A47G 9/02

(52) U.S. Cl. 5/497; 5/495; 29/428

(57) ABSTRACT

A partitioned bed sheet for providing a plurality of semi-separate sleeping areas in a single bed comprised of joining an upper sheet to a lower sheet with a stitch line extending from approximately the foot of the bed parallel to the center line of the bed and terminating at a distance, in part, determined by the circumstances dictating the use of the partitioned bed sheet.

### CROSS-REFERENCE TO RELATED APPLICATIONS

This application claims priority under 35 U.S.C. §119(e) from co-pending U.S. Provisional Patent Application No. 61/349,769, by David Christopher Chose of Houston, Tex., titled “Partitioned Bed Sheets” filed May 28, 2010, which, by this statement, is incorporated herein by reference for all purposes.

### STATEMENT REGARDING FEDERALLY SPONSORED RESEARCH OR DEVELOPMENT

Not Applicable.

### BACKGROUND OF THE INVENTION

People sometimes find themselves forced to share a bed when they would prefer not to do so for any number of reasons. Brothers and sisters have to share hotel beds on family vacations because many hotels do not offer single bed options, even in rooms meant for families. Younger siblings often argue over a “territory grab” of where the dividing line is located so each has their own portion of the bed.

In some situations you may want to share a bed, but still desire privacy or security. When one injures an ankle or foot, the slightest touch can set of a wave of pain interrupting a restful sleep. In such situations, it would be highly desirable to ensure one's bed partner remains on their own side during the night. Many people deal with restless leg syndrome and the involuntary leg movements during the night may prevent a bed partner from getting a restful night's sleep.

Bedding refers to the materials laid above the mattress of a bed for warmth, sanitary proposes, and decorative effect. Bedding sizes are usually made with the dimensions of the bed and mattress for which it is to be used being a large consideration. Bed sizes vary considerably around the world, with most countries having their own standards and terminology. Furthermore, mattresses within a particular area may be of different thicknesses and bedding may be sized for the different thicknesses. Different areas also have different climates, and bedding may again vary to accommodate such climate variations. For instance some environments may require only a light upper sheet while other environments may require a heavier upper sheet, a duvet, and/or a comforter.

### BRIEF DESCRIPTION OF THE DRAWINGS

FIG. 1A illustrates a perspective view of a bed sheeted with a bed sheet set constructed in accordance with an exemplary embodiment of the invention.

FIG. 1B illustrates a cross-sectional view of the bed in FIG. 1A in accordance with an exemplary embodiment of the invention.

FIG. 2 illustrates a top view of a bed sheeted with a bed sheet set constructed in accordance with an exemplary embodiment of the invention.

FIG. 3 illustrates various reinforcing terminations in accordance with an exemplary embodiment of the invention.

### DETAILED DESCRIPTION OF THE PREFERRED EMBODIMENTS

The term bedding can consist of many different parts, from sheets and blankets, to pillows and dust ruffles. The description that follows is concerned primarily with an underlay or lower sheet, and an overlay or upper sheet between which a person would be inclined to lie, and pillows, for elevating the head slightly above the mattress surface, normally located at the head of the bed the distal end being the foot of the bed. Sizes described are general and the application and modifications described can be generalized to apply the concept to bedding of other sizes and countries.

The description that follows is prefaced on two occupants sharing the bed, one on the left and one on the right. Each lies with their head on the pillow at the top of the bed with their body aligned parallel to a centerline which bisects the bed between them from head of the bed to the foot of the bed. The upper sheet is positioned such that the top of the sheet terminates at the head of the bed, but several inches are folded back such that the fold falls just below the pillows. Standard sheet sets are comprised of a lower sheet which may be a flat sheet or a fitted sheet and an upper sheet which is usually a flat sheet.

By stitching or otherwise joining the upper sheet to the lower sheet approximately along the middle of the bed extending from the head of the bed to the foot of the bed, two semi-separate sections or sleeping areas are created. The two sections give occupants some of the privacy and security of separate beds. Additionally the sheets are linked so that they remain a set throughout changing and washings ensuring equal wear and tear of the set as a whole. The stitch line joining the sheets may begin at the foot edge of the sheets, or may begin higher up on the sheet set such that it would be located at the foot of the bed when the sheets are actually installed on the bed. The joining may continue up toward the head of the bed, stopping a various heights depending on the application or situation in which the sheet is to be used. Because of the extra width of the sheet that will be taken up by the extra stitching causing additional peaks and valleys, the preferred embodiment is to have an upper sheet that is wider side to side than that found on a standard bed sheet set for the given bed.

In some situations one does not desire privacy, only security from unintentional bumping or touching, such as when one occupant has an injured foot, such as those to which diabetes patients are prone. Other situations what would benefit from use of such an invention include, but are not limited to those suffering from varicose veins, broken or sprained bones/joints, ingrown toe nails, etc. In such a situation the stitch line may only run to approximately twenty-five percent (25%) of the way to the top of the bed. This is enough to keep the bed partner's feet from inadvertently contacting the injury.

If one occupant has restless leg syndrome they may find themselves inadvertently kicking their bed partner during the night interrupting their sleep. A stitch line which runs to approximately fifty percent (50%) of the way to the top of the bed would prevent such a situation. Each person's legs are isolated in their own area on their own side of the bed. If the two occupant's share a platonic relationship, they may want the privacy and security of a stitch line which runs to approximately seventy-five percent (75%) of the way to the top of the bed, or to just below the pillows.

Joining of the sheets could be accomplished in a number of methods. The preferred method disclosed here is to stitch a double line along a mid-line of the bed. The stitch line begins approximately at the foot of the bed and extends toward the head of the bed to terminate at a point below the head of the bed depending on the embodiment for the situation as outlined above. The stitch line is approximately centered on the bed, but could be offset to either side to give each occupant more or less room. The double stitch line has more reinforcement and strength than a single stitch line. One skilled in the art would appreciate that other sewing methods could be employed to accomplish the general task, including but not limited to, a zigzag stitch, or a plurality of single or dual stitch lines.

The ends of the stitch lines experience more stress than the rest of the stitch line, therefore it is desirable to reinforce the ends of the stitch lines. The preferred method is to use an oval or round shaped stitch pattern which encircles or incorporates the ends of the dual stitch lines. One skilled in the art would appreciate that a number of other options could be used which are in line with the teachings of this description. In one embodiment, the stitch lines could be terminated with a perpendicular cross stitch line. In another embodiment, a box stitch pattern could be used with or without a center reinforcing “X” pattern.

Other methods of joining the upper sheet to the lower sheet would be apparent to one skilled in the art. In one embodiment, the sheets are joined with an adhesive compound. In another embodiment, the threads of the sheets are interwoven such that the two sheets are actually a single sheet. Other embodiments may also take the form of a less permanent attachment between the sheets. In one embodiment the sheets are joined with a hook and loop type fastener such as that commonly referred in the trade as Velcro. In another embodiment a series of buttons or snaps may be used in place of the stitch line. In another embodiment zippers may be used to accomplish the joint.

In one embodiment, rather than an upper and lower sheet, two flat sheets are folded in half and the crease lines are stitched together to form a left and right side. In this embodiment, half of the right sheet and half of the left sheet form the lower sheet, while the other half of the right sheet and the other half of the left sheet form the upper sheet. In the embodiment a portion of the sheets' creases may be cut to allow one side to be folded back as previously described so a person may keep their face out from under the covers while still allowing the lower sheet to reach all the way to the head of the bed.

Some people may find it desirable to sleep on their backs for a variety of reasons but find they tend to roll to their sides or stomach during the night. In another embodiment of the above described invention, a bed sheet may have a line stitched from the foot of the bed to just below the crotch area. Such a line would be positioned so it would run down the mid-line of the bed's occupant. An occupant would then place one leg on either side of the center line so that they are forced to sleep on their back. The center line keeps the legs on their respective sides so one cannot comfortably cross the legs for flipping over or lying on one's side.

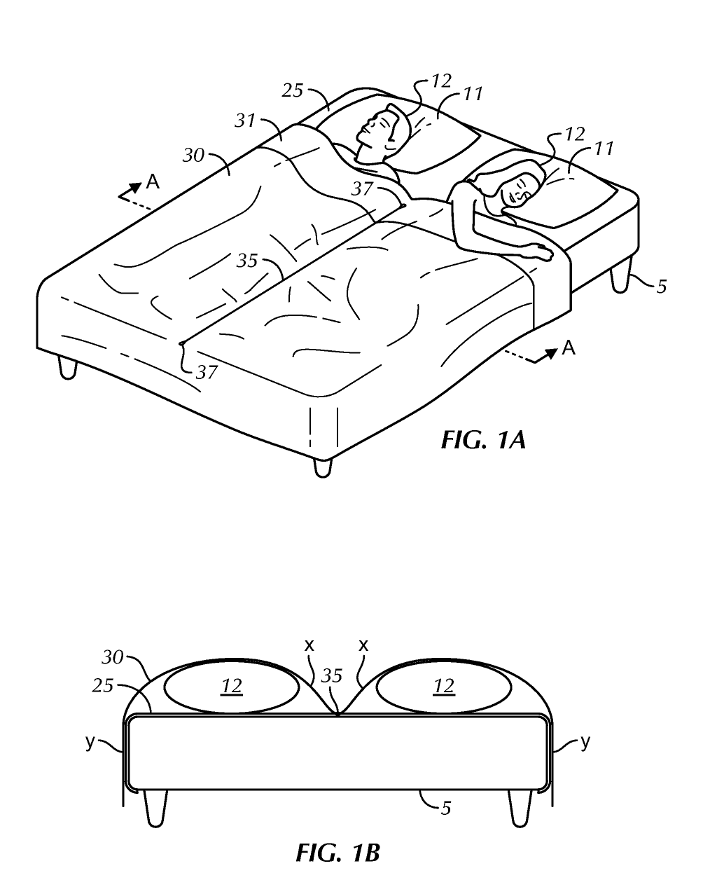

FIG. 1A shows a perspective view of a bed sheeted with a bed sheet set constructed in accordance with an exemplary embodiment of the invention. The bed (5), used by the two occupants (12), has a fitted lower sheet (25) and an upper sheet (30) which is turned back at the upper end (31), just below the pillows (11). A stitch line (35) is position along the center of the bed and is terminated at each end by a reinforcing termination (37).

FIG. 1B illustrates a cross-sectional view as of the bed in FIG. 1A. From the cross-sectional view, the occupants (12) of the bed (5) are shown to be lying above the lower sheet (25), which is a fitted sheet in the illustrated embodiment, and below the upper sheet (30). The occupants' position dictates position so that their head is at the head of the bed and their feet are at the foot of the bed. The stitch line (35) causes an additional valley where the upper sheet (30) dips down (x). This could cause the edges (y) of the upper sheet (30) to be inadequate to cover the occupants (12). Therefore the preferred embodiment includes an upper sheet (30) which is wider than normally used in a standard sheet set for the given bed size.

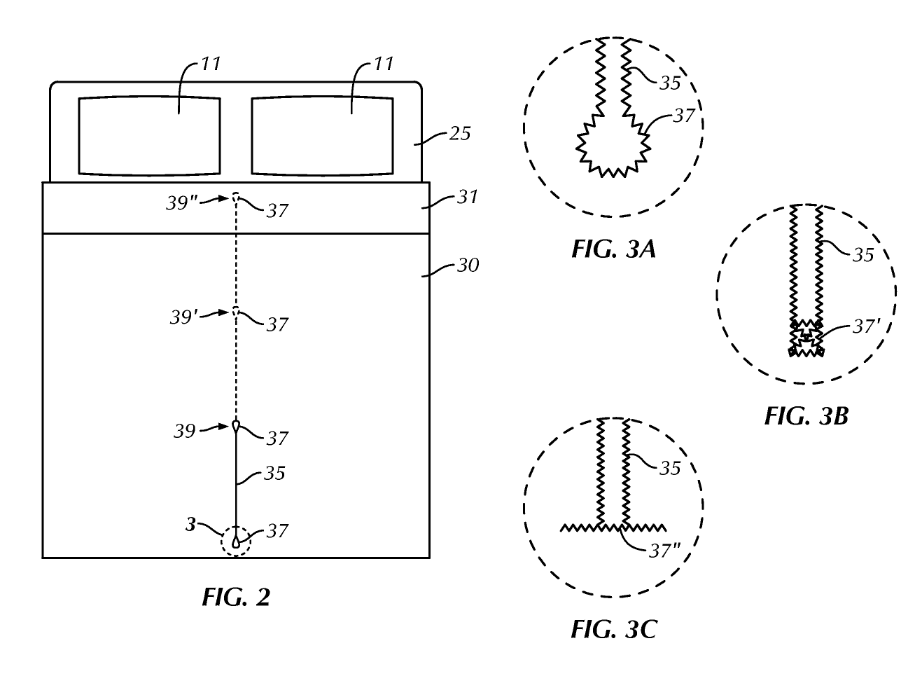

FIG. 2 illustrates a top view of a bed sheeted with a bed sheet set constructed in accordance with an exemplary embodiment of the invention. The pillows (11) are at the head of the bed (5) which is covered with a lower sheet (25) and upper sheet (30) which is turned back (31) at the top edge. A stitch line (35) is located at approximately the center line of the bed, extending from the bottom (3) to a termination point (39) located toward the head of the bed. As illustrated, each end of the stitch line is terminated with a reinforcing termination (37). Depending on the application to be used different embodiments may have the upper termination point located at different position along the center line. For instance, illustrated is an upper termination (39) at approximately 25%. Also illustrated is an upper termination (39′) approximately 50%. Further, illustrated is an upper termination (39″) located at approximately 75%.

FIG. 3 illustrates various reinforcing terminations in accordance with an exemplary embodiment of the invention. FIG. 3A illustrates the preferred embodiment which is to continue the dual stitch line in a circular pattern around a small area and continue back along the same general direction with the second stitch line. FIG. 3B illustrates the use of a box pattern to reinforce the end of the stitch line further reinforced with an optional “X” pattern of stitching. FIG. 3C illustrates the use of a perpendicular termination line which optionally extends past the width of the double stitch line.

Additional benefits of the partitioned sheet set in addition to the semi-separated sleeping areas include the following. It is easier to make the bed after use because the covers are easier to align. One can make or un-make a half of the bed with only minimal disturbance of the other half or of the other occupant. Sheets are less likely to shift to one side or the other during the night or to slide to the foot of the bed causing restless sleep. The stitch line makes it easy to identify the proper orientation of the sheets when making the bed. Aids in keeping a more comfortable sleeping environment by eliminating drafts from a partner turning or getting in or out of the bed.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A partitioned bed sheet comprising;
a lower sheet; and
an upper sheet;
wherein the upper sheet is joined to the lower sheet along the approximate middle of the bed.

2. A partitioned bed sheet, as described in claim 1 wherein the semi-separated sleeping areas are for at least partially separating a plurality of occupants.

3. A partitioned bed sheet, as described in claim 1 wherein the semi-separated sleeping areas are for separating the left foot/leg from the right foot/leg of a single occupant.

4. A partitioned bed sheet, as described in claim 1 wherein the lower sheet is a fitted sheet.

5. A partitioned bed sheet, as described in claim 1 wherein the lower sheet is a flat sheet.

6. A partitioned bed sheet, as described in claim 1 wherein the upper sheet is more than or equal to a width of ten percent (10%) wider than a standard upper sheet for the standard given sheet size.

7. A partitioned bed sheet, as described in claim 1 wherein the upper sheet is joined to divide the bed into a plurality of semi-separated sleeping areas.

8. A partitioned bed sheet, as described in claim 1 wherein the joining is permanent.

9. A partitioned bed sheet, as described in claim 8 wherein the joining is by sewing or stitching.

10. A partitioned bed sheet, as described in claim 9 wherein the sewing or stitching further comprises reinforcing the ends of the stitch line with an oval shaped end stitch to relieve stress and prevent tearing.

11. A partitioned bed sheet, as described in claim 8 wherein the joining is by gluing.

12. A partitioned bed sheet, as described in claim 8 wherein the joining is by weaving the threads to incorporate them into the fabrics.

13. A partitioned bed sheet, as described in claim 1 wherein the joining is separable.

14. A partitioned bed sheet, as described in claim 12 wherein the joining is by a hook and loop fastener.

15. A partitioned bed sheet, as described in claim 12 wherein the joining is by buttons.

16. A partitioned bed sheet, as described in claim 1 wherein the joining extends from the foot of the bed, toward the head of the bed to a distance of at least twenty percent (20%).

17. A partitioned bed sheet, as described in claim 1 wherein the joining extends from the foot of the bed, toward the head of the bed to a distance of at least forty percent (40%).

18. A partitioned bed sheet, as described in claim 1 wherein the joining extends from the foot of the bed, toward the head of the bed to a distance of at least seventy percent (70%).

19. A method of creating a partitioned bed sheet comprising:
aligning a lower sheet with an upper sheet;
joining the two bed sheets along a path wherein such path runs from the foot of the sheets to the head of the sheets.

20. A method of providing a plurality of separate sleeping areas in a bed by:
using a partitioned bed sheet comprised of:
a lower sheet; and
an upper sheet; wherein
the lower sheet is joined to the upper sheet along a line which divides the bed into semi-separate sleeping areas
sheeting the bed with the partitioned bed sheet.
